(19) United States
(12) Patent Application Publication
(10) Pub. No.: US 2025/0242327 A1
(43) Pub. Date: Jul. 31, 2025

(54) POROUS SILICA MATERIALS AND METHODS OF MAKING THE SAME

(71) Applicant: Georgia Tech Research Corporation, Atlanta, GA (US)

(72) Inventors: Carmen Chen, Atlanta, GA (US); Pasquale F. Fulvio, Atlanta, GA (US); Jamie Salinger, Atlanta, GA (US); Krista S. Walton, Atlanta, GA (US)

(21) Appl. No.: 18/855,793

(22) PCT Filed: Apr. 11, 2023
(86) PCT No.: PCT/US2023/065622

§ 371 Date: Oct. 10, 2024

Related U.S. Application Data
(60) Provisional application No. 63/362,795, filed on Apr. 11, 2022.

(51) Int. Cl. B01J 20/04; B01J 20/28

(52) U.S. Cl. CPC B01J 20/046; B01J 20/28004; B01J 20/28011; B01J 20/28016; B01J 20/28061; B01J 20/28064; B01J 20/28066; B01J 20/28073; B01J 20/28076; B01J 20/2808; B01J 20/28083; B01J 20/28085; B01J 20/28092

(57) ABSTRACT

Disclosed herein are porous silica materials comprising a plurality of micropores, each having a pore size from approximately 0.1 nm to approximately 2 nm; a plurality of mesopores, each of the plurality of mesopores having a pore size from approximately 2 nm to approximately 50 nm; and a plurality of macropores, each of the plurality of macropores having a pore size from approximately 50 nm to approximately 50,000 nm. The porous silica materials can comprise a hygroscopic salt material dispersed within the plurality of mesopores such that the hygroscopic salt material resides in the plurality of mesopores. The hygroscopic salt material can be present in the porous silica material in an amount from approximately 10% to approximately 50% by weight, based on the total weight of the porous silica material.

### CROSS-REFERENCE TO RELATED APPLICATIONS

This application claims priority under 35 U.S.C. § 119(e) to U.S. Provisional Application No. 63/362,795, filed on 11 Apr. 2022, and the entire contents and substance of each is incorporated herein by reference in its entirety as if fully set forth below.

### FIELD OF THE DISCLOSURE

The present disclosure relates generally to porous silica materials and methods. Particularly, embodiments of the present disclosure relate to hierarchical silicas with tunable pores and pore volumes as host matrices for hygroscopic salts.

### BACKGROUND

An increasing number of people around the world face water scarcity, as access to surface and underground freshwater vary seasonally and geographically. With the number of remaining options dwindling for accessing freshwater, more nations have turned towards desalination as a source for potable water. In some remote arid regions where there is no easy access to saltwater sources, desalination can be difficult to implement and can cause major negative natural impacts. As such, there is a need to develop an additional technology that can add to existing capabilities for water production in remote areas around the world: atmospheric water harvesting (AWH).

There is a significant amount of water vapor in the atmosphere that can be harvested to produce potable water, even with concentration and gradients varying throughout the globe and with altitude. To capture this water, researchers have developed various AWH techniques. AWH techniques such as fog harvesting, and dewing require high humidity conditions to produce potable water. Thus, they are not suitable techniques for arid regions around the world that are home to more than a third of the world's population. A third AWH technique that can be applied to both arid and humid climates is adsorption-based AWH, where an adsorbent material is used to adsorb and desorb water vapor.

Unfortunately, some commonly used sorbents such as zeolites and silicas are either difficult to regenerate, have low water adsorption loadings, or adsorb water over only a very limited humidity range. For example, zeolites 4A, 5A, 10×, and 13× all require regeneration temperatures from 250° C. to 300° C. Typically, sorbents with significant water adsorption at low relative humidity have small pore sizes and volumes that equate to a low equilibrium capacity. Sorbents that have large pore sizes and volumes will adsorb high amounts of water at high humidity but exhibit low water adsorption loadings at the low relative humidity (RH) range.

What is needed, therefore, are hierarchical silica-salt composite materials with favorable water-sorbent interactions at low % RH as well as the pore volume necessary for adsorbing a significant amount of water at higher humidity conditions. Embodiments of the present disclosure address this need as well as other needs that will become apparent upon reading the description below in conjunction with the drawings.

### BRIEF SUMMARY OF THE DISCLOSURE

The present disclosure relates generally to porous silica materials and methods. Particularly, embodiments of the present disclosure relate to hierarchical silicas with tunable pores and pore volumes as host matrices for hygroscopic salts.

An exemplary embodiment of the present disclosure can provide a porous silica material comprising: a plurality of micropores, each having a pore size from approximately 0.1 nm to approximately 2 nm; a plurality of mesopores having a total mesopore volume from approximately 0.5 cm³/g to approximately 1.5 cm³/g, each of the plurality of mesopores having a pore size from approximately 2 nm to approximately 50 nm; and a plurality of macropores having a total macropore volume from approximately 2 cm³/g to approximately 3 cm³/g, each of the plurality of macropores having a pore size from approximately 50 nm to approximately 50,000 nm.

In any of the embodiments disclosed herein, the porous silica material can comprise a hygroscopic salt material dispersed within the plurality of mesopores such that the hygroscopic salt material resides in the plurality of mesopores.

In any of the embodiments disclosed herein, the hygroscopic salt material can be present in the porous silica material in an amount from approximately 10% to approximately 50% by weight, based on the total weight of the porous silica material.

In any of the embodiments disclosed herein, the porous silica material can have a bulk density from approximately 0.1 g/mL to approximately 0.5 g/mL.

In any of the embodiments disclosed herein, the porous silica material can have a porosity from approximately 50% to approximately 100%.

In any of the embodiments disclosed herein, the porous silica material can have a surface area from approximately 200 m²/g to approximately 1500 m²/g.

In any of the embodiments disclosed herein, the porous silica material can have a water loading from approximately 0.25 g/g to 1 g/g when measured from 20° C. to 30° C. and at 10% relative humidity.

In any of the embodiments disclosed herein, the porous silica material can have a cycle time to reach saturation from 20 minutes to 250 minutes.

Another embodiment of the present disclosure can provide an adsorbent material comprising the porous silica material of any of any of the embodiments disclosed herein.

Another embodiment of the present disclosure can provide an adsorbent material comprising: porous silica particles each having a particle radius from 0.1 μm to 5000 μm, wherein each of the porous silica particles comprises: a plurality of micropores, each having a pore size from approximately 0.1 nm to approximately 2 nm; a plurality of mesopores having a total mesopore volume from approximately 0.5 cm³/g to approximately 1.5 cm³/g, each of the plurality of mesopores having a pore size from approximately 2 nm to approximately 50 nm; and a plurality of macropores having a total macropore volume from approximately 2 cm³/g to approximately 3 cm³/g, each of the plurality of macropores having a pore size from approximately 50 nm to approximately 50,000 nm.

In any of the embodiments disclosed herein, the porous silica material can comprise a hygroscopic salt material dispersed within the plurality of mesopores such that the hygroscopic salt material resides in the plurality of mesopores.

In any of the embodiments disclosed herein, the hygroscopic salt material can be present in the porous silica material in an amount from approximately 10% to approximately 50% by weight, based on the total weight of the porous silica material.

In any of the embodiments disclosed herein, the porous silica material can have a bulk density from approximately 0.1 g/mL to approximately 0.5 g/mL.

In any of the embodiments disclosed herein, the porous silica material can have a porosity from approximately 50% to approximately 100%.

In any of the embodiments disclosed herein, the porous silica material can have a surface area from approximately 200 m²/g to approximately 1500 m²/g.

In any of the embodiments disclosed herein, the porous silica material can have a water loading from approximately 0.25 g/g to 1 g/g when measured from 20° C. to 30° C. and at 10% relative humidity.

In any of the embodiments disclosed herein, the porous silica material can have a cycle time to reach saturation from 20 minutes to 250 minutes.

Another embodiment of the present disclosure can provide an adsorbent material comprising: porous silica particles each having a particle radius from 0.1 μm to 5000 μm, wherein each of the porous silica particles comprises: a plurality of micropores, each having a pore size from approximately 0.1 nm to approximately 2 nm; a plurality of mesopores, each of the plurality of mesopores having a pore size from approximately 2 nm to approximately 50 nm; and a plurality of macropores, each of the plurality of macropores having a pore size from approximately 50 nm to approximately 50,000 nm; and a hygroscopic salt material dispersed within the plurality of mesopores such that the hygroscopic salt material resides in the plurality of mesopores.

In any of the embodiments disclosed herein, the hygroscopic salt material can be present in the porous silica material in an amount from approximately 10% to approximately 50% by weight, based on the total weight of the porous silica material.

In any of the embodiments disclosed herein, the porous silica material can have a bulk density from approximately 0.1 g/mL to approximately 0.5 g/mL.

In any of the embodiments disclosed herein, the porous silica material can have a porosity from approximately 50% to approximately 100%.

In any of the embodiments disclosed herein, the porous silica material can have a surface area from approximately 200 m²/g to approximately 1500 m²/g.

In any of the embodiments disclosed herein, the porous silica material can have a water loading from approximately 0.25 g/g to 1 g/g when measured from 20° C. to 30° C. and at 10% relative humidity.

In any of the embodiments disclosed herein, the porous silica material can have a cycle time to reach saturation from 20 minutes to 250 minutes.

These and other aspects of the present disclosure are described in the Detailed Description below and the accompanying figures. Other aspects and features of embodiments of the present disclosure will become apparent to those of ordinary skill in the art upon reviewing the following description of specific, exemplary embodiments of the present invention in concert with the figures. While features of the present disclosure may be discussed relative to certain embodiments and figures, all embodiments of the present disclosure can include one or more of the features discussed herein. Further, while one or more embodiments may be discussed as having certain advantageous features, one or more of such features may also be used with the various embodiments of the invention discussed herein. In similar fashion, while exemplary embodiments may be discussed below as device, system, or method embodiments, it is to be understood that such exemplary embodiments can be implemented in various devices, systems, and methods of the present disclosure.

### BRIEF DESCRIPTION OF THE DRAWINGS

The accompanying drawings, which are incorporated in and constitute a part of this specification, illustrate multiple embodiments of the presently disclosed subject matter and serve to explain the principles of the presently disclosed subject matter. The drawings are not intended to limit the scope of the presently disclosed subject matter in any manner.

FIGS. 1A and 1B illustrate adsorption isotherms for example porous silica materials, in accordance with the present disclosure.

FIG. 2 illustrates mercury intrusion plots for examples of a porous silica material to evaluate pore volume, in accordance with the present disclosure.

FIGS. 3A and 3B are plots of pore size distribution for examples of a porous silica material, in accordance with the present disclosure.

FIGS. 4A and 4B illustrate water adsorption isotherms for examples of a porous silica material, in accordance with the present disclosure.

FIGS. 5A and 5B illustrate water adsorption cycles for examples of a porous silica material, in accordance with the present disclosure.

FIGS. 6A and 6B illustrate water desorption cycles for examples of a porous silica material, in accordance with the present disclosure.

FIGS. 7A and 7B are plots of adsorption isotherms and pore size distributions for an adsorbent material containing a porous silica material, in accordance with the present disclosure.

FIGS. 8A-G are scanning electron microscope (SEM) images of an adsorbent material containing a porous silica material, in accordance with the present disclosure.

### DETAILED DESCRIPTION

To combat water scarcity in remote areas around the world, adsorption-based atmospheric water harvesting (AWH) is desirable as a technology that can be used alongside existing water production capabilities. However, commonly used adsorbents either adsorb water at low humidity or at high humidity; they cannot operate over the entire humidity range. The adsorbents that take up appreciable water loadings at low humidity are difficult to regenerate, requiring high temperatures over 250° C. Disclosed herein are hierarchical silica-salt composites that both exhibit high water adsorption loadings under dry and humid conditions. The total water vapor loading, kinetics, and heats of water adsorption for both silica-salt composites were investigated. As hierarchical silicas have tunable pores and large pore volumes, these materials can serve as effective host matrixes for hygroscopic salts, such as LiCl. These hierarchical pores can play a significant role in water adsorption. Without wishing to be bound by any particular scientific theory, micropores and some smaller mesopores can act as “storage” sites for hygroscopic salt whereas larger mesopores and macropores can increase the accessibility of water vapor into the silica. Using this mix of pores, the porous silica materials disclosed herein can achieve greater than 0.4 g H₂O/g composite at 10% RH and 27° C. Additionally, the present disclosure can provide that the salt-impregnated silica and bare silica can have the same heat of adsorption, for instance, 80-90 kJ/mol. Without wishing to be bound by any particular scientific theory, the results can suggest that the H-bond interactions can be similar for both systems and that the primary mechanism at play can be water cluster adsorption/desorption. Despite the similar energies, the hygroscopic salt (e.g., LiCl) containing materials exhibited considerably slower kinetics than bare silica materials.

Soft-templated mesoporous silicates can be prepared using allyl ionic surfactants, or triblock copolymers, with tailorable pore sizes and excellent water stability. These porous silica materials can appear as candidates for AWH technologies. A major challenge at approximately 24-25° C., however, is that large pore silicas, such as MCM-41 and SBA-15, can exhibit low water capacities at % RH below 50% RH (˜0.14 g/g) and ˜70% RH (˜0.13 g/g), respectively. For these systems, the % RH (relative pressure) for water adsorption can be appropriately correlated to the Kelvin equation, and materials having pore larger than 4 nm can exhibit condensation steps above 50% RH.

Another key challenge to an efficient AWH process is developing an adsorbent material that can not only adsorb significant amounts of water vapor in dry conditions but can also be suitable for a wide humidity range with enhanced water accessibility to the adsorption sites. Hierarchical silicas are mesoporous silicas that feature a bimodal or trimodal pore system of interconnected micro-, meso-, and/or macropores. The synthesis of soft-templated mesoporous silicas can offer the advantage of combining different pore templating agents that can lead to different pore systems that are interconnected (e.g., the self-assembly of silica precursors with alkylammonium and polyethylene glycol (PEG) surfactants).

After calcinations, allylammonium surfactants templated small primary mesopores, PEG yielded large secondary mesopores and macropores. Hence, a hierarchical pore network can be induced when a mixture containing surfactant, polymer, and silicon alloxide precursor undergoes concurrent gelation and phase separation processes. Changing the rates of gelation and phase separation can directly impact pore formation in the hierarchical silica. Such control over material properties can be possible by modifying the ratio of the starting reagents or the synthesis temperature.

Due to the tunable pore sizes and large pore volumes characteristic of hierarchical silicas, these materials can serve as effective host matrixes for hygroscopic salt. Immobilizing hygroscopic salts in these porous substrates can yield stable composites for water adsorption even at high relative humidity. For instance, hygroscopic salts, such as lithium chloride (LiCl) and calcium chloride (CaCl₂)) can adsorb significant amounts of water vapor, but face issues like deliquescence, where the salt becomes a liquid upon adsorbing water, and agglomeration. Incorporation of hygroscopic salt into porous materials can be a potential strategy to merge the benefits of both components, as the high surface area of the substrate ensures water vapor accessibility to the immobilized salts. For example, silica gel can be impregnated with LiBr, MgCl₂, and CaCl₂ to increase the water adsorption loading at 25° C. and 39% RH for a silica gel composite impregnated with 17 wt % CaCl₂) from 0.06 g/g to 0.33 g/g after salt impregnation. Another example can include synthesized silica gel composites using LiCl, LiBr, and CaCl₂. The salt impregnation can improve adsorption loadings from ˜0.13 g/g to ˜0.43 g/g at 60% RH at 20° C. for the best performing sample. In both examples, the water capacities of the silica gel composites can be ultimately limited by their total pore volumes, none of which exceeded 1.26 cm³/g.

On the other hand, composite systems having hierarchical pore structure, such as that of activated carbon fiber (ACF)-colloidal silica-LiCl composites, can exhibit a total water adsorption loading of up to 2.29 g/g while having a total pore volume of less than 0.07 cm³/g. Such differences from using silica gels can potentially arise from the presence of micropores and macropores from the ACF for anchoring silica and LiCl and for water vapor diffusion, respectively. The combined effect of these pores can ensure accessibility to the dispersed LiCl within the secondary mesopores of the agglomerated colloidal silica particles.

Finally, the colloidal silica can confer mechanical stability to the ACF composites, as LiCl@ACF systems were found to lack mechanical rigidity in the presence of water vapor. While water adsorption in materials having unimodal or bimodal pore systems with micropores and mesopores can be used, systems containing additional macropores have been limited to nanocomposites. Having information on the water adsorption of silicas, especially those having tailorable mesopores and with reproducible widths and pore volumes from soft-templating, could pave the way for better sorbents for AWH use.

Disclosed herein are water-stable hierarchical silicas that can be prepared and characterized and finally investigated for water adsorption after LiCl salt impregnation. Both silicas can be prepared using a modified recipe for the self-assembly of silica using cetyltrimethylammonium bromide (CTAB) surfactant and PEG 35,000 polymer. The present materials can be prepared in large syntheses batches of up to 50 g. It was found that upscaling this silica synthesis can lead to materials having some micropores, in addition to secondary (interparticle) mesopores and macropores. Whereas pre-mixing of CTAB with PEG prior to hydrolysis of the silica source can be used to yield primary mesopores interconnected to macropores by secondary mesopores. Increasing the ratio of CTAB with respect to that of PEG can result in increased primary mesopore volumes. The LiCl impregnated silicas having only textural pores can lead to higher water adsorption at high relative humidity. The presence of primary mesopores templated by CTAB can lead to LiCl composites having comparable water vapor loadings at low relative humidity but consist of lesser amounts of total LiCl. The added benefit of the latter materials can be the reproducibility of results given the nature of the primary mesopores templated by CTAB. The premixing of CTAB and PEG further can yield materials having greater macropore volumes.

Moreover, the effect of the solvent used to impregnate these silicas with LiCl, and that of silica particle size distribution for ball-milled samples are also disclosed herein for the total water vapor loading, kinetics, and heats of water adsorption. Ball-milled silica samples can have comparable kinetics due to the overall large mean particle size. Finally, all silica and LiCl containing materials can exhibit the same heats of water adsorption from microcalorimetry studies, of 80-90 kJ/mol. Without wishing to be bound by any particular scientific theory, the results suggest that the H-bond interactions can be similar for all systems, and that the primary mechanism can be water cluster adsorption/desorption. Despite the similar energies, the LiCl containing materials exhibited considerably slower kinetics than bare silica materials.

Although certain embodiments of the disclosure are explained in detail, it is to be understood that other embodiments are contemplated. Accordingly, it is not intended that the disclosure is limited in its scope to the details of construction and arrangement of components set forth in the following description or illustrated in the drawings. Other embodiments of the disclosure are capable of being practiced or carried out in various ways. Also, in describing the embodiments, specific terminology will be resorted to for the sake of clarity. It is intended that each term contemplates its broadest meaning as understood by those skilled in the art and includes all technical equivalents which operate in a similar manner to accomplish a similar purpose.

Herein, the use of terms such as “having,” “has,” “including,” or “includes” are open-ended and are intended to have the same meaning as terms such as “comprising” or “comprises” and not preclude the presence of other structure, material, or acts. Similarly, though the use of terms such as “can” or “may” are intended to be open-ended and to reflect that structure, material, or acts are not necessary, the failure to use such terms is not intended to reflect that structure, material, or acts are essential. To the extent that structure, material, or acts are presently considered to be essential, they are identified as such.

By “comprising” or “containing” or “including” is meant that at least the named compound, element, particle, or method step is present in the composition or article or method, but does not exclude the presence of other compounds, materials, particles, method steps, even if the other such compounds, material, particles, method steps have the same function as what is named.

It is also to be understood that the mention of one or more method steps does not preclude the presence of additional method steps or intervening method steps between those steps expressly identified.

The components described hereinafter as making up various elements of the disclosure are intended to be illustrative and not restrictive. Many suitable components that would perform the same or similar functions as the components described herein are intended to be embraced within the scope of the disclosure. Such other components not described herein can include, but are not limited to, for example, similar components that are developed after development of the presently disclosed subject matter.

The disclosed porous silica materials can comprise micropores, mesopores, and macropores. The micropores can be defined as pores having a pore size from approximately 0.1 nm to approximately 2 nm (e.g., from 0.2 nm to 2 nm, from 0.3 nm to 2 nm, from 0.4 nm to 2 nm, from 0.5 nm to 2 nm, from 0.6 nm to 2 nm, from 0.7 nm to 2 nm, from 0.8 nm to 2 nm, from 0.9 nm to 2 nm, or from 1 nm to 2 nm). Alternatively, or in addition, the micropores can be defined as pores having any pore size of 2 nm or less (e.g., 1.9 nm or less, 1.8 nm or less, 1.7 nm or less, 1.6 nm or less, 1.5 nm or less, 1.4 nm or less, 1.3 nm or less, 1.2 nm or less, 1.1 nm or less, or 1 nm or less).

The mesopores can be defined as pores having a pore size from approximately 2 nm to approximately 50 nm (e.g., from 2 nm to 45 nm, from 2 nm to 40 nm, from 2 nm to 35 nm, from 2 nm to 30 nm, from 2 nm to 25 nm, from 2 nm to 20 nm, from 2 nm to 15 nm, from 2 nm to 10 nm, from 3 nm to 50 nm, from 4 nm to 50 nm, from 5 nm to 50 nm, from 6 nm to 50 nm, from 7 nm to 50 nm, from 8 nm to 50 nm, from 9 nm to 50 nm, from 10 nm to 50 nm, from 15 nm to 50 nm, from 20 nm to 50 nm, or from 25 nm to 50 nm).

The macropores can be defined as pores having a pore size from approximately 50 nm to approximately 50 nm to approximately 50,000 nm (e.g., from 60 nm to 50,000 nm, from 70 nm to 50,000 nm, from 80 nm to 50,000 nm, from 90 nm to 50,000 nm, from 100 nm to 50,000 nm, from 110 nm to 50,000 nm, from 120 nm to 50,000 nm, from 130 nm to 50,000 nm, from 140 nm to 50,000 nm, from 150 nm to 50,000 nm, from 160 nm to 50,000 nm, from 170 nm to 50,000 nm, from 180 nm to 50,000 nm, from 190 nm to 50,000 nm, or from 200 nm to 50,000 nm). Alternatively, or in addition, the macropores can be defined as pores having any pore size of 50 nm or greater (e.g., 60 nm or greater, 70 nm or greater, 80 nm or greater, 90 nm or greater, 100 nm or greater, 110 nm or greater, 120 nm or greater, 130 nm or greater, 140 nm or greater, 150 nm or greater, 160 nm or greater, 170 nm or greater, 180 nm or greater, 190 nm or greater, or 200 nm or greater).

Furthermore, the porous silica material can have various pore volumes, including a total micropore volume, a total mesopore volume, and a total macropore volume. The total mesopore volume can be from approximately 0.5 cm³/g to approximately 1.5 cm³/g (e.g., from 0.6 cm³/g to 1.4 cm³/g, from 0.7 cm³/g to 1.3 cm³/g, from 0.8 cm³/g to 1.2 cm³/g, or from 0.9 cm³/g to 1.1 cm³/g). The total macropore volume can be from approximately 2 cm³/g to approximately 3 cm³/g (e.g., from 2.1 cm³/g to 2.9 cm³/g, from 2.2 cm³/g to 2.8 cm³/g, from 2.3 cm³/g to 2.7 cm³/g, or from 2.4 cm³/g to 2.6 cm³/g).

The porous silica material can comprise a hygroscopic salt material. The hygroscopic salt material can be dispersed within the mesopores in the porous silica material. In other words, the hygroscopic salt material can reside in the mesopores. Suitable examples of a hygroscopic salt material can include, but are not limited to, LiCl, CaCl₂, LiBr, NaCl, CaBr₂, as well as the like, and combinations thereof.

The hygroscopic salt material can be present in the porous silica material in an amount from approximately 10% to approximately 50% (e.g., from 20% to 50%, from 30% to 50%, from 40% to 50%, from 10% to 40%, from 10% to 30%, or from 10% to 20%) by weight, based on the total weight of the porous silica material.

The porous silica material can have a porosity from approximately 50% to approximately 100% (e.g., from 55% to 100%, from 60% to 100%, from 65% to 100%, from 70% to 100%, from 75% to 100%, from 80% to 100%, from 85% to 100%, from 90% to 100%, or from 95% to 100%).

The porous silica material can have a surface area from approximately 200 m²/g to approximately 1500 m²/g (e.g., from 250 m²/g to 1500 m²/g, from 300 m²/g to 1500 m²/g, from 350 m²/g to 1500 m²/g, from 400 m²/g to 1500 m²/g, from 450 m²/g to 1500 m²/g, from 500 m²/g to 1500 m²/g, from 550 m²/g to 1500 m²/g, from 600 m²/g to 1500 m²/g, from 650 m²/g to 1500 m²/g, from 700 m²/g to 1500 m²/g, from 750 m²/g to 1500 m²/g, from 800 m²/g to 1500 m²/g, from 850 m²/g to 1500 m²/g, from 900 m²/g to 1500 m²/g, from 950 m²/g to 1500 m²/g, or from 1000 m²/g to 1500 m²/g).

The porous silica material can have a water loading from approximately 0.25 g/g to 1 g/g (e.g., from 0.3 g/g to 1 g/g, from 0.35 g/g to 1 g/g, from 0.4 g/g to 1 g/g, from 0.45 g/g to 1 g/g, from 0.5 g/g to 1 g/g, from 0.55 g/g to 1 g/g, from 0.6 g/g to 1 g/g, from 0.65 g/g to 1 g/g, from 0.7 g/g to 1 g/g, from 0.75 g/g to 1 g/g, from 0.8 g/g to 1 g/g, from 0.85 g/g to 1 g/g, from 0.9 g/g to 1 g/g, or from 0.95 g/g to 1 g/g) when measured from 20° C. to 30° C. and at 10% relative humidity.

The porous silica material can have a cycle time to reach saturation from 20 minutes to 250 minutes (e.g., from 30 minutes to 240 minutes, from 40 minutes to 230 minutes, from 50 minutes to 220 minutes, from 60 minutes to 210 minutes, from 70 minutes to 200 minutes, from 80 minutes to 190 minutes, from 90 minutes to 180 minutes, from 100 minutes to 170 minutes, from 110 minutes to 160 minutes, or from 120 minutes to 150 minutes).

The porous silica particles can be included in an adsorbent material in a variety of form factors. For instance, the adsorbent material can comprise porous silica particles as disclosed herein in milled particles. Alternatively, or in addition, the particles can be pressed into pellets, spray coated or dip coated onto surfaces, formed into extrudates with appropriate binding agent, or any other methods/form factors as desired.

The porous silica particles can have a particle radius from 0.1 μm to 5000 μm (e.g., 0.5 μm to 5000 μm, from 1 μm to 5000 μm, from 1 μm to 4000 μm, from 1 μm to 3000 μm, from 1 μm to 2000 μm, from 1 μm to 1000 μm, from 1 μm to 500 μm, from 1 μm to 100 μm, from 1 μm to 50 μm, from 1 μm to 10 μm, from 0.5 μm to 100 μm, or from 0.1 μm to 100 μm).

Reference will now be made in detail to exemplary embodiments of the disclosed technology, examples of which are illustrated in the accompanying drawings and disclosed herein. Wherever convenient, the same references numbers will be used throughout the drawings to refer to the same or like parts.

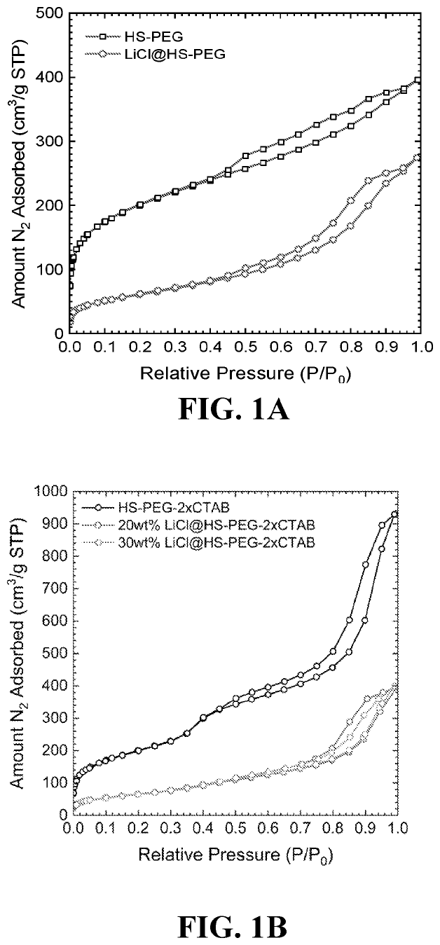

Two hierarchical silicas are disclosed herein as illustrative examples, HS-PEG and HS-PEG-2×CTAB. The disclosed porous silica materials can be synthesized using different CTAB reagent ratios and slightly different procedures as detailed in the Examples below. In the HS-PEG-2×CTAB synthesis, the increase in CTAB reagent combined with the pre-dissolution of CTAB with PEG prior to the addition of the silica precursor TEOS can lead to a higher total mesopore volume compared to HS-PEG. To characterize the surface area and pore volume of the materials, corresponding nitrogen adsorption isotherms for the two silicas are shown in FIGS. 1A and 1B.

Both nitrogen isotherms for HS-PEG and HS-PEG-2×CTAB are type IV, characteristic of mesoporous materials. Unlike HS-PEG, two distinct capillary condensation steps can be seen for HS-PEG-2×CTAB at a P/Pₒ of ˜0.35 and ˜0.80, which can correlate to mesopore formation by two distinct mechanisms. Specifically, the step at P/Pₒ˜0.35 can correspond to mesopores templated by CTAB, whereas the P/Pₒ of ˜0.80 step can correspond to larger secondary mesopores templated by PEG. The hysteresis loops more closely resemble the H-2 type. These are characteristic of materials having constricted mesopores. The additional step in the desorption hysteresis for HS-PEG-2×CTAB can be constricted secondary slit-like pores.

The corresponding PSD curves corroborate with this analysis, as the first condensation step can correspond to mesopores of approximately 4 nm in size. The second condensation step can correspond to pores in the range of 10 nm to 50 nm. The PEG polymer can be polydisperse, causing the partial interpenetration of PEG chains around the silica-CTAB domains during synthesis, thus leading to a secondary soft-templating reaction. For the HS-PEG sample, the CTAB template did not yield similar well-defined small mesopores. Instead, the calculated PSD curve can indicate only a broad distribution of large mesopores with additional micropores. The hydrolysis and segregation of the silica-PEG domains can occur faster than the self-assembly between silica-CTAB system, thus leading to interparticle silica pores templated by PEG. The CTAB did not form a mesophase, and instead, it was trapped within the forming silica framework, thus yielding micropores after its removal.

The mesopore volume taken from the nitrogen adsorption isotherms at a P/Pₒ of 0.99 can be 1.44 cm³/g for HS-PEG-2×CTAB and 0.61 cm³/g for HS-PEG. The Brunaeur-Emmett-Teller (BET) surface areas calculated at a P/Pₒ range of 0.05 to 0.2 can be similar for both materials as HS-PEG-2×CTAB had a BET surface area of 727 m²/g compared to 719 m²/g for HS-PEG.

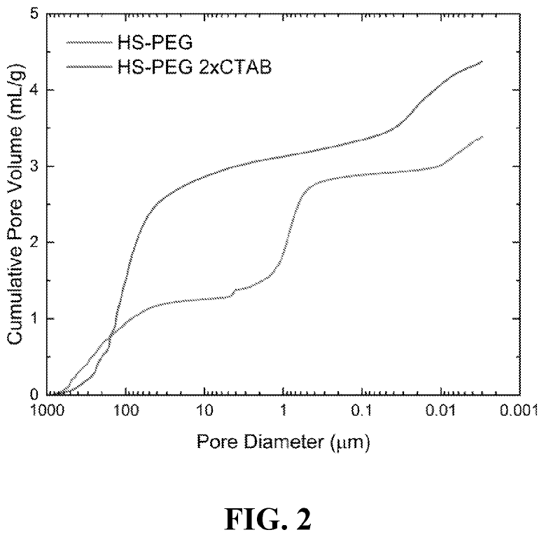

The total pore volume taken from mercury intrusion at 60,000 psia (FIG. 2) can be 4.37 cm³/g for HS-PEG-2×CTAB and 3.38 cm³/g for HS-PEG. This can result in a total macropore volume of 2.93 cm³/g for HS-PEG-2×CTAB and 2.77 cm³/g for HS-PEG. The bulk density and porosity can be 0.18 g/mL and 81.4%, respectively, for HS-PEG-2×CTAB and 0.24 g/mL and 80.5%, respectively, for HS-PEG. These similar bulk compositions for both silicas can suggest that the modified synthesis primarily serves to tune the mesopore volume of the resulting silica structure while maintaining very similar overall compositions, without wishing to be bound by any particular scientific theory.

After characterization, hierarchical silicas can be impregnated with 20 wt %, 25 wt % and 30 wt % LiCl solutions to determine the best performing composite materials. LiCl can be chosen as it has the highest water capacity in arid conditions compared to some other hygroscopic salts. As used herein, all composites are referred to with the naming convention of salt@host-matrix. The nitrogen adsorption isotherms for the optimum LiCl@HS-PEG and LiCl@HS-PEG-2×CTAB samples are shown in FIGS. 1A and 1B.

For HS-PEG, the optimum salt solution can be 25 wt % LiCl salt in methanol. On the other hand, the optimum salt solutions for HS-PEG-2×CTAB can be 20 wt % in a 50/50 mix of water and methanol and 30 wt % in methanol. The nitrogen adsorption isotherms in FIG. 1 are type IV, with the H-2 hysteresis loops. The hysteresis loop for the composite LiCl@HS-PEG is better defined than that of the HS-PEG material. As for LiCl@HS-PEG-2×CTAB, the condensation step nearly disappeared, and the second step indicates a decreased pore volume.

The drop in total pore volume and the loss in surface area of the silicas after LiCl impregnation can suggest a pore filling mechanism with LiCl.

The surface areas for both 20 wt % and 30 wt % LiCl@HS-PEG-2×CTAB was 243 m²/g and the surface area for LiCl@HS-PEG was 222 m²/g. On the other hand, the mesopore volume for 20 wt % and 30 wt % LiCl@HS-PEG-2×CTAB was reduced to 0.62 cm³/g and the mesopore volume for LiCl@HS-PEG was lowered to 0.43 cm³/g.

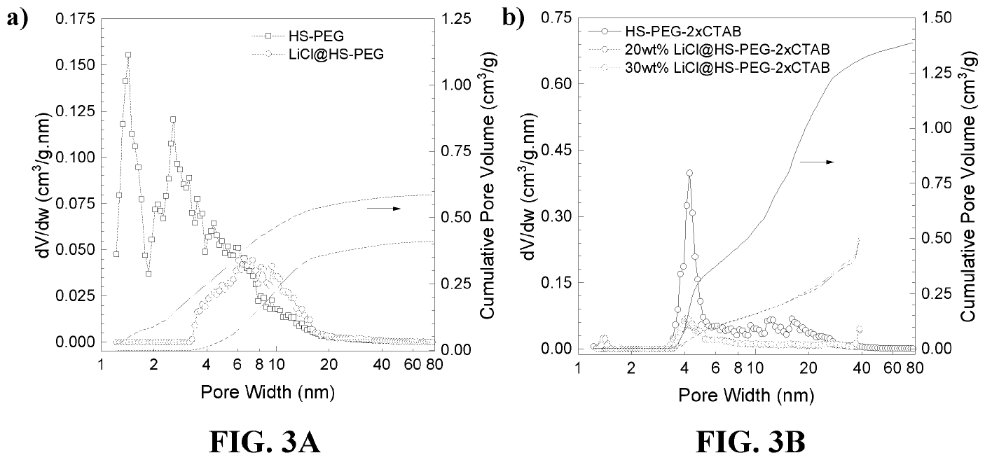

To investigate the effect of LiCl impregnation on the pores of HS-PEG and HS-PEG-2×CTAB, pore size distributions can be calculated using non-local density functional theory (NLDFT) for cylindrical pores in a silica material as seen in FIGS. 3A and 3B.

The pore size distribution for HS-PEG is broader than that of HS-PEG-2×CTAB, which follows the broad capillary condensation step seen in FIG. 1A, indicating a wider range of pore sizes created. After LiCl impregnation, there can be a noticeable decrease in the micropores and small mesopores for both salt-impregnated silica materials. This shift in the pores can suggest that LiCl is primarily contained within the smaller pores, which act as salt “storage” sites. The larger mesopores can have some salt impregnated in them, but to a lesser extent than that of the smaller pores. The larger mesopores are expected to increase the accessibility for both salt and water into the internal particle pores templated by CTAB.

While water has primarily been used in other salt-impregnation studies, as an illustrative example, methanol can be selected for LiCl impregnation studies due to the hydrophobicity of HS-PEG. Calcining mesoporous silica can increase its hydrophobicity. In calcined materials, the surface silanols can condense to form siloxane bridges (Si-O-Si) which are hydrophobic. The surface hydroxyl groups can be regenerated when silicas are exposed to water vapor. Prior to that, simply using methanol as a solvent can allow for increasing the amount of LiCl that intrudes into the pores of the silica materials. This hypothesis can be verified by quantifying the salt content for LiCl@HS-PEG and LiCl@HS-PEG-2×CTAB samples using Graphite Furnace Atomic Absorption Spectroscopy (GFAAS). The best performing LiCl@HS-PEG and LiCl@HS-PEG-2×CTAB samples are tabulated in Table I.

TABLE I
Calculated LiCl content and experimental water
loadings at 27° C. 10% RH for select LiCl
salt impregnations of HS-PEG and HS-PEG-2xCTAB.

| | | | LiCl wt % | Water Loading |
|---|---|---|---|---|
| | LiCl wt % | | calculated | at 27° C. 10% |
| Hierarchical | Used for | | using | RH using |
| Silica | Impregnation | Solvent | GFAAS | 3Flex (g/g) |
| HS-PEG | 25 | Water | 51.4 | 0.401 |
| | | Methanol | 38.5 | 0.467 |
| | | 50/50 Water | 45.9 | 0.309 |
| | | Methanol | | |
| HS-PEG- | 20 | Water | 38.3 | 0.348 |
| 2xCTAB | | Methanol | 36.0 | 0.351 |
| | | 50/50 Water | 26.8 | 0.421 |
| | | Methanol | | |
| | 30 | Water | 49.3 | 0.313 |
| | | Methanol | 16.6 | 0.436 |

In Table I, the amount of LiCl content in HS-PEG was highest in samples that had water as the solvent. A similar trend was also observed in LiCl@HS-PEG-2×CTAB samples. The lone exception to this pattern was HS-PEG impregnated with 20 wt % LiCl solution, whereby the sample that had water as the solvent had the lowest amount of salt impregnated. Without wishing to be bound by any particular scientific theory, one explanation can be that this sample perhaps had more leaching of LiCl salt during the impregnation process than the other 20 wt % samples. In general, the increased loading from a water-based LiCl solution over the methanol solutions can be explained by the higher solubility of LiCl in water compared to methanol, without wishing to be bound by any particular scientific theory. During the salt impregnation process, it can be possible that some of the methanol evaporates, causing previously dissolved LiCl to partially precipitate. This loss of solvent can make it more difficult for salt to infiltrate into the porous matrix of HS-PEG, resulting in lower impregnation amounts.

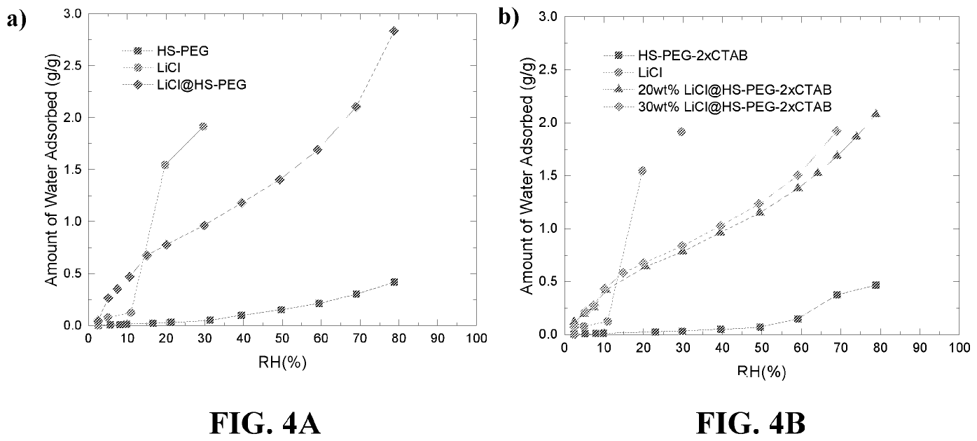

Water adsorption isotherms for best performing LiCl@HS-PEG and LiCl@HS-PEG-2×CTAB samples are shown in FIGS. 4A and 4B. Pre-exposing these samples to 50% RH water vapor can lead to silica surface hydroxylation, with consequent increased surface hydrophilicity. This step can encourage reproducibility of the adsorption by silicas and LiCl composites. Both silica materials exhibit the type V adsorption isotherm. Without wishing to be bound by any particular scientific theory, this type of isotherm can indicate that the interactions between adsorbate molecules are stronger than the forces between adsorbate and adsorbent surfaces. The HS-PEG isotherm can have a broad condensation step that is similar to its N₂ isotherm and can be attributed to its broad PSD. The HS-PEG-2×CTAB has a well-defined step within the range of 60 and 80% RH. This range agrees with silicas having mesopore widths of 4 to 6 nm.

The salt impregnated samples have a type II adsorption isotherm. Both composites can greatly outperform the unimpregnated samples across the entire humidity range of RHs measured. This enhancement in the amount adsorbed, especially at low RH, can result from water loading by LiCl and can also be seen in pure LiCl salt. In addition to the continuous water adsorption by the salt, multilayers of water molecules may form on the external surfaces, namely, large mesopores and macropores of the composites. Given the large mesopores found in both composites, higher RHs are required to discern the onset of the water condensation step.

Several comparative porous sorbents impregnated with LiCl are listed in Table II along with their water adsorption loadings under dry conditions. At low relative humidity conditions, LiCl@HS-PEG can outperform these other select sorbents. Salt impregnation can lead to improvements in water capacity across the whole humidity regime. The resulting water capacity of the salt@sorbent matrix not only outperforms the bare sorbent, but also outperforms the bulk hygroscopic salt. Without wishing to be bound by any particular scientific theory, this can indicate that there is a synergistic relationship between salt confinement and water harvesting capacity.

Upon comparing the water vapor loadings at 27° C. 10% RH for the nine samples listed in Table I, it appears the samples that performed the best had the lowest salt content. However, this was not necessarily the case for HS-PEG and HS-PEG-2×CTAB impregnated with non-optimum amounts of LiCl salt. These mixed results suggest that besides the amount of salt impregnated in the material, an additional factor dictating water vapor adsorption is the potential pore-blocking by loaded LiCl, without wishing to be bound by any particular scientific theory. Both the amount of LiCl salt as well as the arrangement of LiCl within the pores can impact the amount of water vapor adsorbed by the material. When comparing the two silicas with each other, the salt content in the best performing LiCl@HS-PEG sample can be much higher than the best performing LiCl@HS-PEG-2×CTAB samples. This difference in salt content suggests the larger mesopore volume present in HS-PEG-2×CTAB can play a significant role in water vapor adsorption. The larger mesopores in HS-PEG-2×CTAB can allow for increased transport of water vapor into the pores compared to HS-PEG at low relative humidity. These data suggest there is a balance that can be optimized between how much salt is impregnated into the host matrix and the water vapor adsorption kinetics.

TABLE II
Water loadings of comparative LiCl sorbents to LiCl@HS-PEG

| | Temperature | Water | |
|---|---|---|---|
| | and Relative | Loading | |
| Sorbent | Humidity Tested | (g/g) | |
| LiCl@HS-PEG | 27° C., 10% RH | 0.467 | g/g |
| LiCl/CaCl₂@Zeolite 13X²⁸ | 20° C., 20% RH | ~0.15 | g/g |
| LiCl@Activated Carbon²⁹ | 20° C., 10% RH | ~0.20 | g/g |
| LiCl@Silica Gel Type B²² | 20° C., 10% RH | ~0.13 | g/g |
| LiCl@MIL-100(Fe)³⁰ | 24.85° C., 10% RH | ~0.13 | g/g |
| LiCl@UiO-66(Zr)³¹ | 19.85° C., 10% RH | 0.271 | g/g |
| LiCl@HKUST-1(Cu)²⁵ | 25° C., 30% RH | 0.50 | g/g |
| LiCl@MIL-101(Cr)³² | 25° C., 10% RH | ~0.13 | g/g |

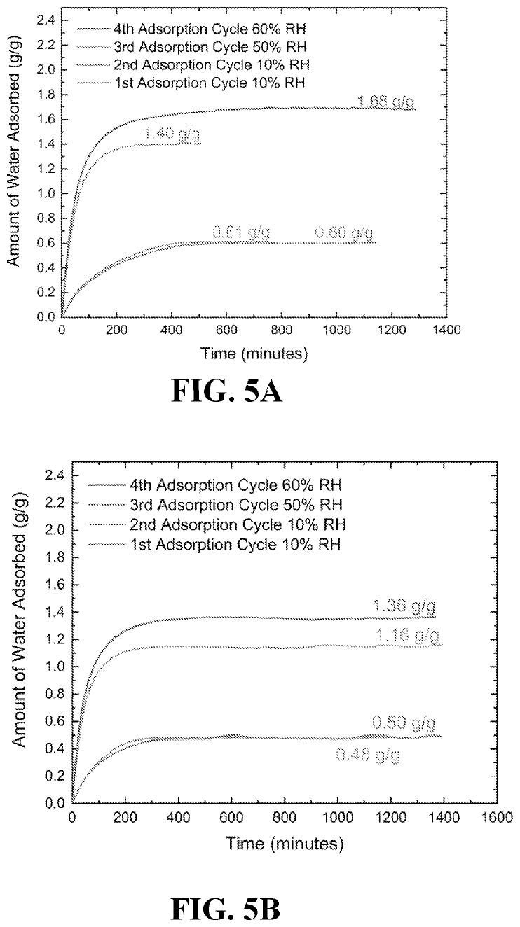

A necessary consideration in the development of adsorbents for AWH is their cyclic stability and subsequent regeneration. In FIGS. 5A and 5B, the LiCl@HS-PEG and LiCl@HS-PEG-2×CTAB (20 wt % in 50/50 methanol-water mix) samples that performed the best at 10% RH at 27° C. during the volumetric studies on the 3Flex were chosen for gravimetric water adsorption studies. Each sample can be subjected to four consecutive adsorption-desorption cycles, with two cycles at 10% RH, one cycle at 50% RH, and the last cycle at 60% RH. Both samples can maintain the same water adsorption loading at 10% RH and had comparable loadings at the higher humidity range when compared to data from the 3Flex studies. At 49% RH at 27° C., the LiCl@HS-PEG sample adsorbed 1.403 g/g and the LiCl@HS-PEG-2×CTAB sample adsorbed 1.149 g/g. At 59% RH at 27° C., the LiCl@HS-PEG sample adsorbed 1.689 g/g and the LiCl@HS-PEG-2×CTAB sample adsorbed 1.378 g/g at 59% RH. These similar loadings suggest that the LiCl did not leach out of the pores of the HS-PEG during the water adsorption-desorption measurements. Additionally, as the data in FIGS. 5A and 5B show, the LiCl@HS-PEG-2×CTAB sample reached equilibrium faster than the LiCl@HS-PEG sample. This faster equilibration can be attributed to the higher mesopore volume present in the HS-PEG-2×CTAB silica allowing for increased accessibility of water vapor, without wishing to be bound by any particular scientific theory. Notably, LiCl@HS-PEG-2×CTAB had a cycle time of ˜250 minutes for each relative humidity tested. This is faster than the 700 minutes needed for LiCl@UiO-66(Zr) to reach saturation at 50% RH at 25° C., but slower than the 20 minutes needed for LiCl@MIL-100(Fe) at 30% RH at 25° C.

In atmospheric water harvesting, the amount of water able to be desorbed from a sorbent is equally as important as the water capacity of the sorbent. Samples used in cycling analysis, LiCl@HS-PEG (25 wt % in methanol) and LiCl@HS-PEG-2×CTAB (20 wt % in 50/50 methanol-water mix), can be chosen for desorption analysis. After exposure to 10% RH at 27° C., samples can be heated to 150° C. under static conditions (no purge flow and no vacuum) for temperature swing desorption. Once the sample was fully desorbed, a purge stream can be introduced to decrease the pressure and flush humid air out of the system to prep the sample for another cycle of adsorption. The temperature can also be decreased back to 27° C. following complete desorption.

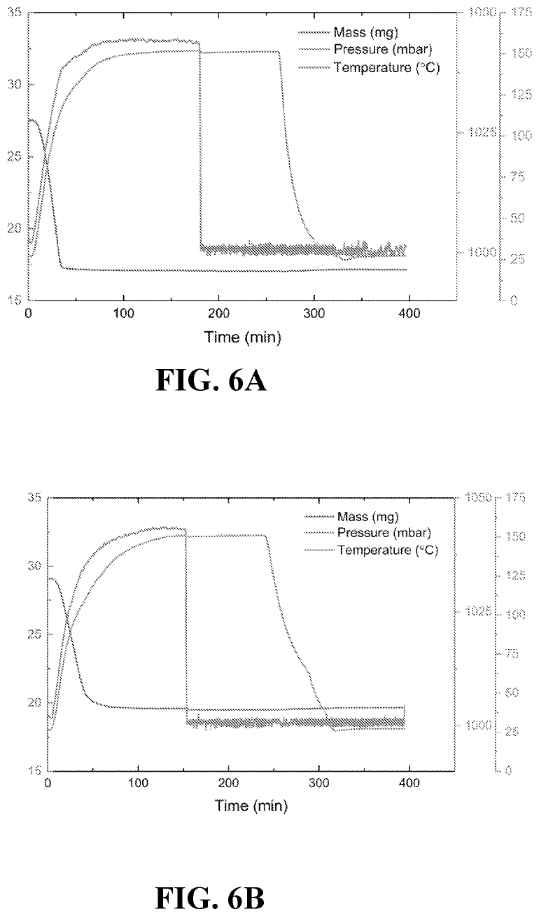

In FIGS. 6A and 6B, the desorption of LiCl@HS-PEG (25 wt % in methanol) and LiCl@HS-PEG-2×CTAB (20 wt % in 50/50 methanol-water mix) is shown. As the temperature of each sample was increased to 150° C. the mass of the sample decreased, eventually reaching the starting mass of the sample after activation and prior to adsorption. Similarly, complete desorption can occur relatively quickly (˜90s). This indicates that even with a high water loading at low humidity, the salt-impregnated silicas are able to be fully regenerated relatively quickly, resulting in an increased water harvesting efficiency, without wishing to be bound by any particular scientific theory. The heats of adsorption for selected HS-PEG and LiCl@HS-PEG samples can be discerned through isothermal adsorption studies at a constant flow rate of 200 ml/min in a TGA/DSC instrument outfitted with a humidity generator and a water vapor furnace. The quantity of water adsorbed can be determined gravimetrically, while the heat flow throughout the adsorption process can be monitored. The calculated enthalpy of adsorption was found to range from 80 to 85 kJ/mol for HS-PEG and LiCl@HS-PEG samples. The similarity in the adsorption enthalpy suggests that the host-guest interactions of the adsorption at 10% RH can be similar in strength. Interestingly, the data confirms an increased time to saturation in the LiCl@HS-PEG samples, which can be attributed to the kinetics of the water-LiCl hydration process without wishing to be bound by any particular scientific theory.

Prior to implementation into real-life applications, one of the key material post-processing considerations is optimization of the particle size of the sorbent material. For example, smaller and more uniform particle sizes can be used for more efficient packing of the adsorbent material. One method for creating smaller particle sizes is through high-energy ball milling. Ball milling can be used to break down zeolites and other materials into smaller particles. For example, high-energy ball milling can be used to reduce the particle sizes of TiO₂/SiO₂ xerogel powders so that they can be packed better into dye-sensitized solar cells. However, ball milling has not yet been evaluated for its potential to create uniform and structurally stable adsorbent particles for AWH applications. To this end, HS-PEG can be ball-milled at various time lengths from 30 minutes to 12 hours using a SPEX CertiPrep 8000M Mixer/Mill.

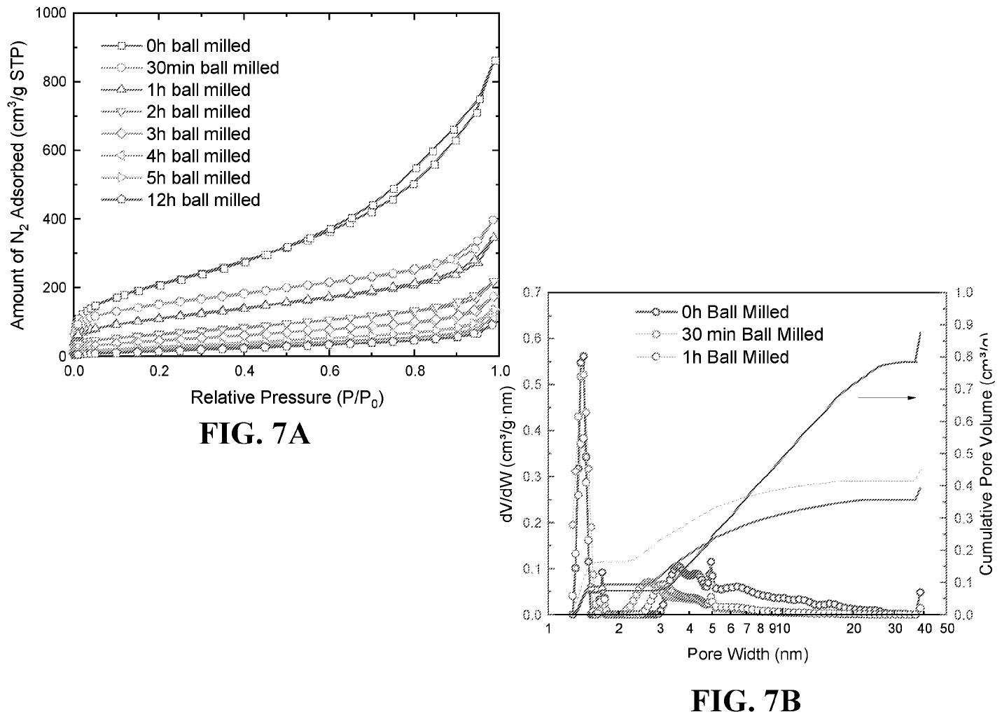

To investigate the effect of ball milling time on the structural stability of the hierarchical silica HS-PEG, N₂ physisorption isotherms at 77K can be measured for HS-PEG samples ball-milled at seven different time points ranging from 30 minutes to 12 hours (FIGS. 7A and 7B). N₂ physisorption isotherms can indicate a loss in Brunauer, Emmett, and Teller (BET) surface area and pore volume of HS-PEG after just 30 minutes of ball milling. At 12 hours of ball milling, almost no BET surface area and pore volume remains in HS-PEG, as seen in Table III. Additionally, starting at 2 hours of ball milling, the HS-PEG lost 70% of its original surface area and 76% of its original pore volume. Based on this data, it appears that the structural integrity of HS-PEG cannot be maintained past 1 hour of ball milling. Hg porosimetry measurements indicate very similar bulk properties between the 30 minutes and 1-hour samples.

The 30 minutes ball-milled sample can have a total pore volume of 1.39 mL/g, bulk density of 0.47 g/mL, and a porosity of 65.4%. On the other hand, the 1-hour ball-milled sample can have a total pore volume of 1.33 mL/g, bulk density of 0.47 g/mL, and a porosity of 62.9%.

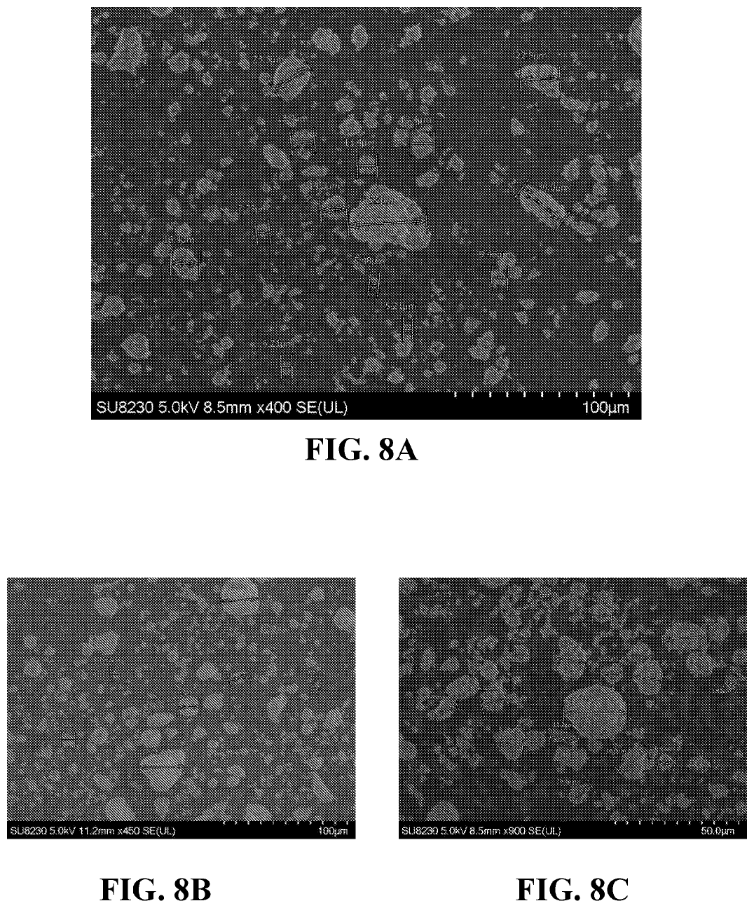

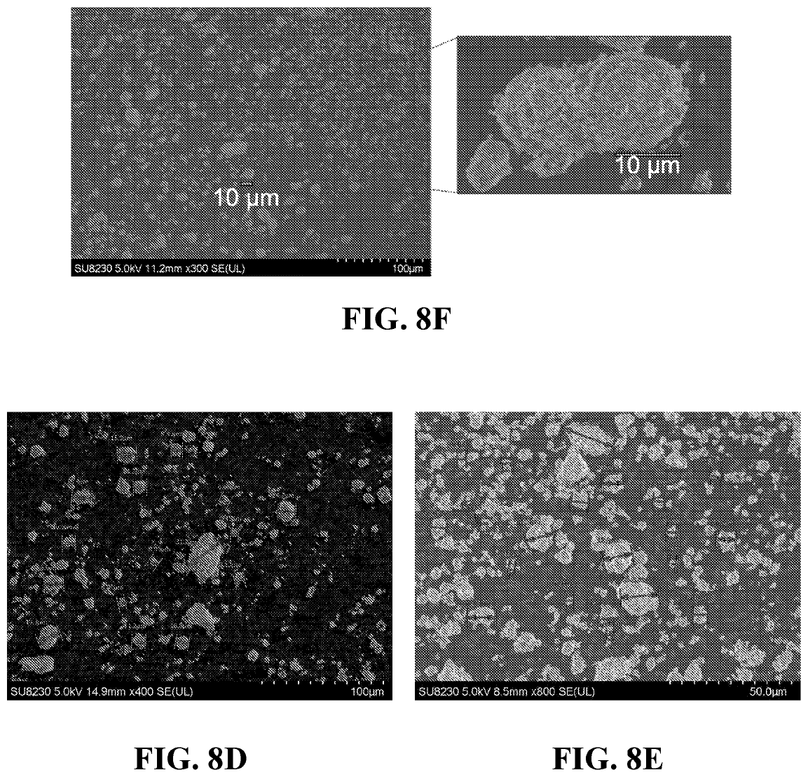

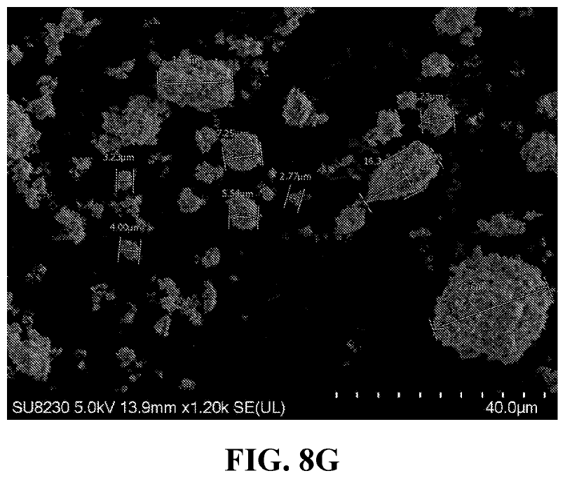

Additionally, an approximate particle size distribution can also be determined from the SEM images of ball-milled HS-PEG (FIGS. 8A-G) taken with a Hitachi SU8230 instrument. The approximate particle radius listed in Table III can be estimated by halving the diameter of the largest particle present in SEM images. Generally, a gradual decrease in particle size across the ball-milled samples can be seen until a plateau is reached at ˜10 nm after 4 hours of ball milling.

TABLE III
BET surface areas and pore volumes for 0-12 h ball-milled HS-PEG.
Approximate particle radius determined by selecting the largest
particle radius in SEM images taken of the samples.

| Ball | | Pore Volume | Approximate |
|---|---|---|---|
| Mill | BET Surface | (cm³/g) at | Particle |
| Hours | Area (m²/g) | P/P₀ = 0.90 | Radius (μm) |
| 0 | 770 | 0.975 | 50 |
| 0.5 | 544 | 0.434 | 22.5 |
| 1 | 400 | 0.367 | 19 |
| 2 | 236 | 0.231 | 12.5 |
| 3 | 169 | 0.175 | 15 |
| 4 | 88 | 0.099 | 10 |
| 5 | 106 | 0.124 | 10 |
| 12 | 66 | 0.085 | 10 |

In conclusion, two illustrative hierarchical silicas, HS-PEG and HS-PEG-2×CTAB, can be synthesized with different amounts of mesopores and mesopore volume and impregnated with the hygroscopic salt LiCl. With the inclusion of the LiCl in the micropores and mesopores in the host silica matrix, the ensuing novel silica-salt composites can show enhanced water adsorption behavior across the entire humidity range. Notably, the water loading seen at 10% RH at 27° C. (>0.4 g/g) can meet or outperforms similar salt-MOF materials tested at temperatures ranging from 20-30° C. Furthermore, due to the increased number of mesopores and mesopore volume in HS-PEG-2×CTAB, the composite silica-salt material can exhibit faster adsorption kinetics than HS-PEG. These faster kinetics suggests that mesopores can play a role in increasing the accessibility of water vapor into the composite silica-salt material. The results show that hierarchical silica-salt composite materials can be used for AWH in a wide range of relative humidities. Furthermore, high-energy ball milling of HS-PEG can be conducted to create more uniform particle sizes. However, reduced particle sizes can result in decreased BET surface areas and pore volumes after more than 1 hour of ball milling. Interestingly, HS-PEG ball-milled for 30 minutes and 1 hour still can feature significant porosity. The findings suggest short-term ball milling can be a viable large-scale option to reduce particle size in silica materials without sacrificing significant performance. In general, the results highlight the need to evaluate the mechanical stability of adsorbents in tandem with other characterization techniques prior to their use for AWH applications. Ultimately, the findings can be applied to other mesoporous materials to develop the next generation of AWH adsorbents.

Certain embodiments and implementations of the disclosed technology are described above with reference to block and flow diagrams of systems and methods and/or computer program products according to example embodiments or implementations of the disclosed technology. It will be understood that one or more blocks of the block diagrams and flow diagrams, and combinations of blocks in the block diagrams and flow diagrams, respectively, can be implemented by computer-executable program instructions. Likewise, some blocks of the block diagrams and flow diagrams may not necessarily need to be performed in the order presented, may be repeated, or may not necessarily need to be performed at all, according to some embodiments or implementations of the disclosed technology.

### EXAMPLES

The following examples are provided by way of illustration but not by way of limitation.

Polyethylene glycol (PEG, 35,000 g/mol), nitric acid (70%), tetraethylorthosilicate (TEOS, 98%), cetyltrimethylammonium bromide (CTAB, n-16, ≥98%), ammonium hydroxide (28-30% NH₃ basis), and lithium chloride (≥99%) were purchased from Sigma Aldrich.

Into a beaker, 9.8068 g of polyethylene glycol (PEG, 35000 g/mol, Sigma Aldrich) was added. While under gentle stirring, small amounts of reagents were dosed into the beaker in the order written: 137 μL of H₂O, 8.2 μL HNO₃ (Sigma Aldrich, 70%) and 0.116 mL of tetraethoxysilane (TEOS, Sigma Aldrich, 98%). Subsequently, 109.2 mL of H₂O and 6.526 mL HNO₃ was poured into the beaker. Once the solution turned clear, 92.1 mL of TEOS was added. After the TEOS completely dissolved, 13.5389 g of cetyltrimethylammonium bromide (CTAB, Sigma Aldrich, ≥98%) was added. After the solution turned clear again, the beaker with sol was placed in a programmable oven for 3 days at 40° C. During this time, the sol slowly turned into one cylindrically-shaped yellow and white solid precipitate. For the next step, the precipitate is broken up into chunks gently using a spatula. These chunks are added to a 100 mL Teflon liner until they reached ½ inch from the top of the liner. 20 mL of 1M NH₄OH (Sigma Aldrich, 28-30% NH₃ basis) solution is added to the Teflon liner. The Teflon liners are sealed up in autoclaves and subsequently placed in an oven for 9 h at 90° C.

54.575 mL of H₂O was added into a round bottom flask suspended in a silicone oil bath. To the water, 2.299 mL of 70% HNO₃ was added to produce an aqueous nitric acid solution. To the nitric acid solution, 2.3594 g of 35,000 g/mol PEG was added under stirring and subsequently stirred until the PEG was completely dissolved and a clear solution remained. Next, 14.0571 g of CTAB was added into the flask under stirring. The solution was then heated to 60° C. to assist in the dissolution of CTAB into the solution. Once the CTAB was completely dissolved, the mixture was lifted out of the silicone oil bath and allowed to cool back down to room temperature. Once cooled, 46.05 mL of TEOS was slowly poured into the flask under stirring. Once the mixture was clear, it was poured into a beaker and allowed to age uncovered in an oven at 40° C. for 72 hours. Following the completion of the aging process, the monolith was broken up into chunks with a spatula. Next, the monolith chunks were washed with a 1M NH₄OH solution at 90° C. for 9 hours. To a 47 mL Teflon liner, 25 mL of total liquid was added (23.26 mL H₂O and 1.720 mL of 1M NH₄OH) the monolith chunks were added into the Teflon liner until they were completely covered with 1 inch of solution above the monolith. The Teflon liners were sealed in autoclaves and placed in an oven at 90° C. for 9 hours.

After cooling back down to room temperature, the silica monoliths were poured into a clean beaker and subsequently drained of residual solution. To the monoliths, a 0.1 M HNO₃ solution was added. After 10 minutes with occasional stirring, the nitric acid solution was drained. Next, the monoliths were washed with a 25% ethanol and water solution. After soaking for 10 minutes, the solution was drained. This process was repeated 3 times. Next, the beaker of monolith was covered with aluminum foil (with holes for venting) and dried in an oven at 60° C. for 72 hours. Following the drying process, the monoliths were calcined at 550° C. for 5 hours with a ramp rate of 1° C./min.

Into a 100 mL beaker, lithium chloride (LiCl, Sigma Aldrich, ≥99%) was added (amounts depending on solution wt % desired) along with 50 g of solvent. The solvents were either 100% methanol, 100% water, or a 50/50 mix of methanol and water. The solution was then stirred until the LiCl was completely dissolved. Once dissolved, HS-PEG or HS-PEG-2×CTAB was added into the beaker at a ratio of 5 mg of adsorbent per 1 mL of solvent. The mixture is then left to gently stir for 24 hours. Following impregnation, the impregnated HS-PEG is collected from the LiCl solution and dried in an oven at 110° C. for 24 hours. In this work, all composites will be referred to with the naming convention of salt@host-matrix. Next, the LiCl@HS-PEG composites are washed in a sealed humidity chamber set to 50% RH (ambient temperature) for 24 hours to remove external salt from the surface of the material. Finally, the LiCl@HS-PEG is dried in an oven at 110° C. for 24 hours. This wash and drying process is repeated one additional time for a total of two washes for each LiCl@HS-PEG sample.

Nitrogen adsorption measurements at 77K were obtained using a Quantachrome Quadrasorb SI volumetric analyzer (Quantachrome, Boynton Beach, FL), and a 3Flex volumetric analyzer (Micromeritics, Norcross, GA). Prior to measurements, all samples were outgassed under vacuum and at 150° C. overnight. The total pore volumes were obtained directly from the adsorption isotherms at the p/p₀ of 0.90-0.95, and the total surface areas calculated using the Brunnauer-Emett-Teller (BET) method within the p/p₀ range of 0.05-0.20. The pore size distributions were calculated using non-local density functional theory (NLDFT) method for an oxide reference surface.

Mercury porosimetry measurements were conducted at Micromeritics Instrument Corp. using a Micromeritics MicroActive AutoPore V 9600 version. Mercury intrusion was measured from a pressure of 0.10 psia to 61,000 psia to obtain pore data from 1,000 to 0.001 μm at 18.63° C. Prior to measurements, all samples were degassed at 150° C. for 5 hours.

Water vapor adsorption isotherms at 27° C. were obtained using a Micromeritics 3Flex Surface Characterization Analyzer. Prior to water measurements, all samples were activated at 150° C. for 14 hours under vacuum. For the cycling studies at 27° C., a Hiden Isochema IGA-3 was used instead of the Micromeritics 3Flex Surface Characterization Analyzer. Samples were activated in situ at 150° C. under vacuum overnight, until no significant weight change could be detected. Air was used as the carrier gas for water adsorption measurements on the IGA-3 to best match real environmental conditions. After adsorption measurements, the samples were reactivated in situ at 1 bar and 150° C.

Approximately ˜5 mg of LiCl@HS-PEG or LiCl@HS-PEG-2×CTAB were dissolved in 2 mL of 4M potassium hydroxide (KOH), diluted to 25 mL. 1 mL of the solution is diluted to 10 mL, creating an effective dilution of ˜5 mg of sorbent in 250 mL of solution. Samples were analyzed in a Shimadzu 7000 series Graphite Furnace Atomic Absorption Spectrometer with a lithium lamp. The LiCl amount was determined from the Li quantification, and the LiCl quantification per mass of sorbent was derived from the total weight of the sample.

Samples of HS-PEG silica were divided into separate two-gram samples and ball-milled for varying amounts of time, between 30 minutes and 12 hours, using a SPEX CertiPrep 8000M Mixer/Mill. The silica was dry-loaded into a silicon nitride vial along with two 1.3 cm silicon nitride balls. The inner diameter of the silicon nitride vial is 3.8 cm, and the height of the vial is 6.7 cm. The 8000M Mixer/Mill is a high-energy ball mill that can grind 0.2 to 10 grams of sample at a time. It operates by shaking the vial back-and-forth in a three-dimensional swing that resembles a figure-8 motion. After ball-milling, the fine-powdered sample was allowed to cool prior to collection.

A Hitachi SU-8230 SEM was used to collect images of ball-milled silica. Silica samples were placed on top of carbon tape. The Hitachi SU-8230 SEM uses a cold field emission gun, one of three possible electron guns that can be used. Cold field emission guns emit a brighter beam and need a better vacuum compared to tungsten hairpin filament guns and lanthanum hexaboride filament guns.

While the present disclosure has been described in connection with a plurality of exemplary aspects, as illustrated in the various figures and discussed above, it is understood that other similar aspects can be used, or modifications and additions can be made to the described aspects for performing the same function of the present disclosure without deviating therefrom. For example, in various aspects of the disclosure, methods and compositions were described according to aspects of the presently disclosed subject matter. However, other equivalent methods or composition to these described aspects are also contemplated by the teachings herein. Therefore, the present disclosure should not be limited to any single aspect, but rather construed in breadth and scope in accordance with the appended claims.

1. A porous silica material comprising:
micropores having a pore size from approximately 0.1 nm to approximately 2 nm;
mesopores having a total mesopore volume from approximately 0.5 cm³/g to approximately 1.5 cm³/g and a pore size from approximately 2 nm to approximately 50 nm; and
macropores having a total macropore volume from approximately 2 cm³/g to approximately 3 cm³/g and a pore size from approximately 50 nm to approximately 50,000 nm.

2. The porous silica material of claim 1 further comprising a hygroscopic salt material dispersed within the mesopores such that the hygroscopic salt material resides in the mesopores.

3. The porous silica material of claim 2, wherein the hygroscopic salt material is present in the porous silica material in an amount from approximately 10% to approximately 50% by weight, based on the total weight of the porous silica material.

4. The porous silica material of claim 1, wherein at least one of:
the porous silica material has a bulk density from approximately 0.1 g/mL to approximately 0.5 g/mL;
the porous silica material has a porosity from approximately 50% to approximately 100%;
the porous silica material has a surface area from approximately 200 m²/g to approximately 1500 m²/g;
the porous silica material has a water loading from approximately 0.25 g/g to 1 g/g when measured from 20° C. to 30° C. and at 10% relative humidity; or
the porous silica material has a cycle time to reach saturation from 20 minutes to 250 minutes.

5.-9. (canceled)

10. An adsorbent material comprising:
the porous silica material of claim 1;
wherein the porous silica particles have a particle radius from 0.1 μm to 5000 μm.

11. The adsorbent material of claim 10, wherein:
the porous silica material further comprises a hygroscopic salt material dispersed within the mesopores such that the hygroscopic salt material resides in the mesopores; and
the hygroscopic salt material is present in the porous silica material in an amount from approximately 20% to approximately 50% by weight, based on the total weight of the porous silica material.

12. (canceled)

13. The adsorbent material of claim 11, wherein the porous silica material has a:
bulk density from approximately 0.1 g/mL to approximately 0.5 g/mL;
porosity from approximately 50% to approximately 100%;
surface area from approximately 200 m²/g to approximately 1500 m²/g;
water loading from approximately 0.25 g/g to 1 g/g when measured from 20° C. to 30° C. and at 10% relative humidity; and
cycle time to reach saturation from 20 minutes to 250 minutes.

14.-24. (canceled)

25. A material comprising:
a hierarchical silica featuring a trimodal pore system of interconnected micro-, meso-, and macropores; and
a hygroscopic salt material dispersed within the mesopores such that the hygroscopic salt material resides in the mesopores;
wherein the hygroscopic salt material is present in the material in an amount from approximately 10% to approximately 50% by weight, based on the total weight of the material.

26. The porous silica material of claim 2, wherein the hygroscopic salt material is present in the porous silica material in an amount from approximately 10% to approximately 20% by weight, based on the total weight of the porous silica material.

27. The porous silica material of claim 2, wherein the hygroscopic salt material is selected from a group consisting of LiCl, CaCl₂, LiBr, NaCl, CaBr₂, and a combination thereof.

28. The porous silica material of claim 2, wherein the porous silica material has an enthalpy of adsorption from approximately 80 to approximately 85 kJ/mol.

29. The porous silica material of claim 2, wherein:
the hygroscopic salt material comprises LiCl;
the LiCl is present in the porous silica material in an amount from approximately 16% to approximately 50% by weight, based on the total weight of the porous silica material; and
the porous silica material has a water loading from approximately 0.31 g/g to 0.47 g/g when measured at 27° C. and at 10% relative humidity.

30. The material of claim 25, wherein the material has at least one of:
a bulk density from approximately 0.1 g/mL to approximately 0.5 g/mL;
a porosity from approximately 50% to approximately 100%;
a surface area from approximately 200 m²/g to approximately 1500 m²/g;
a water loading from approximately 0.25 g/g to 1 g/g when measured from 20° C. to 30° C. and at 10% relative humidity; or
a cycle time to reach saturation from 20 minutes to 250 minutes.

31. The material of claim 25, wherein the material has:
a bulk density from approximately 0.1 g/mL to approximately 0.5 g/mL;
a porosity from approximately 50% to approximately 100%;
a surface area from approximately 200 m²/g to approximately 1500 m²/g;
a water loading from approximately 0.25 g/g to 1 g/g when measured from 20° C. to 30° C. and at 10% relative humidity; and
a cycle time to reach saturation from 20 minutes to 250 minutes.

32. The material of claim 25, wherein the hygroscopic salt material is present in the material in an amount from approximately 10% to approximately 20% by weight, based on the total weight of the material.

33. The material of claim 25, wherein the hygroscopic salt material is selected from a group consisting of LiCl, CaCl₂, LiBr, NaCl, CaBr₂, and a combination thereof.

34. The material of claim 25, wherein the material has an enthalpy of adsorption from approximately 80 to approximately 85 kJ/mol.

35. The material of claim 2, wherein:
the hygroscopic salt material comprises LiCl;
the LiCl is present in the material in an amount from approximately 16% to approximately 50% by weight, based on the total weight of the material; and
the material has a water loading from approximately 0.31 g/g to 0.47 g/g when measured at 27° C. and at 10% relative humidity.
